(19) United States
(12) Patent Application Publication
(10) Pub. No.: US 2018/0075225 A1
(43) Pub. Date: Mar. 15, 2018

(54) INPUT AUTHENTICATION METHOD

(71) Applicants: Te-Luen Lai, New Taipei City 234 (TW); Wen-Kai Tai, Taipei City 106 (TW)

(72) Inventors: Te-Luen Lai, New Taipei City 234 (TW); Wen-Kai Tai, Taipei City 106 (TW)

(21) Appl. No.: 15/474,884

(22) Filed: Mar. 30, 2017

(30) Foreign Application Priority Data
Sep. 9, 2016 (TW) 105129234

(51) Int. Cl. G06F 21/31; G06F 21/60

(52) U.S. Cl. CPC G06F 21/31; G06F 3/0488; G06F 21/602

(57) ABSTRACT

An input authentication method for verifying an accuracy of a password data inputted by a user, comprising the steps providing a sensing unit for sensing and reading a decryption data inputted by the user; providing a timing unit used for calculating decryption time intervals lapsed between decryption passwords of the decryption data; providing a recording unit for recording predefined encryption data and corresponding encryption time intervals as well as the decryption data and the decryption time intervals corresponding to the decryption passwords; providing a password verification unit for comparing whether the encryption data matches with the decryption data inputted; and providing a time interval verification unit for generating a number of tolerance intervals based on the predefined tolerance degrees set by the user in order to determine whether the decryption data inputted by the user is accurate based on whether the decryption time intervals inputted by the user are within the corresponding tolerance intervals.

### BACKGROUND OF THE INVENTION

### Field of the Invention

The present invention is related to an input authentication method, in particular, to a method using a time interval of password input as an authentication basis.

### Description of Related Art

In the modern society, the use of mobile devices and/or mobile smart electronic devices such as smartphones, Personal Digital Assistants (PDAs) and tablet computers has become an essential part of daily life. Consequently, with concerns on the issues of personal privacy and information security, the aforementioned personal electronic devices are typically equipped with lockout protection mechanism in order to prevent the data stored in the devices from stealing or reading arbitrarily by anyone other than the owners of the devices. In addition to prevent accidental touches on the electronic devices while placing inside the pockets or bags of the owners, the lockout mechanism of all electronic devices requires users to unlock via screen or keyboard operations. The most well-known lockout mechanisms include the encryption mechanisms of the password lockout and pattern lockout. When the user wishes to unlock the electronic device, he or she can unlock the electronic device by either inputting password to perform comparisons with the predefined password or unlocking pattern to perform comparisons with the unlocking pattern such that the lockout mechanism can be unlocked if successful. This is a common method capable of providing a certain level of security protection for unlocking. Nevertheless, after a long period of use of electronic devices, traces and stretches of sweat stains and finger prints may be left on the touch control screen of smartphones so that a portion of such traces and stretches may be used by interested party to crack the password combination and/or the pattern of the smartphone for stealing important personal information such as privacy information and financial data in the smartphones. For example, a lot of users install shopping software on their smartphones and bind their bank account with the mobile phone number for being able to directly transfer funds through the application programs; therefore, when their smartphones are lost or stolen, an unscrupulous party in possession of the mobile phone may use the traces and stretches left on the screen to crack the locking mechanism of the phone, which may then lead to the occurrence of the fund in the bank account associated with the mobile phone number being stolen, or the application program in the mobile phone may be used illegally to transfer funds or perform financial related transactions, possibly leading to tremendous financial loss of the mobile phone original owner.

In view of the hidden security flaw associated with the authentication unlocking of the aforementioned electronic devise, the present invention seeks to provide a more secured and reliable unlocking method with simple operations in order to reduce the risks of financial loss or even personal safety due to the stolen of electronic devices being used illegal by others.

Accordingly, the present invention provides an input authentication method such that in addition to the predefined password combination or particular pattern as the unlocking basis, a predefined time internal is further introduced among each predefined input password characters and a predefined time internal is further introduced among each predefined particular pattern stroke in order to be used as the authentication data for unlocking thereof. In other words, during a user inputting a password combination or a particular pattern, he or she needs to not only input the correct predefined password combination or particular pattern for unlocking but also to satisfy the predefined time interval for each input password character or the predefined time interval among the strokes of the particular pattern during the input of the password combination or the particular pattern. Consequently, if the electronic device were stolen. An interested party may be able to correctly guessing the password combination or particular pattern based on the traces and/or stretches on the screen for cracking the unlocking mechanism of the phone. However, such interested party still cannot accurately know the correct input time interval such that he or she would not be able to pass the unlocking mechanism. As a result, the present invention is able to provide an unlocking method capable of effectively increasing the difficulty for unlocking electronic devices while making such method in a simple, secured and reliable manner.

### SUMMARY OF THE INVENTION

An objective of the present invention is to overcome the problem of inadequate security of the unlocking authentication mechanism adopted on the currently existing electronic devices by providing an input authentication method in order to enhance the strength of the unlocking authentication mechanism and to increase the security thereof.

The present invention provides an input authentication method, used for verifying an accuracy of a password data inputted by a user, said method comprising the following steps. Providing a sensing unit for sensing and reading a decryption data inputted by the user; wherein the sensing unit is one of a physical keyboard, a virtual keyboard panel, a touch control device, a writing pad and a combination thereof; therefore, each one of the decryption data and the encryption data generated can also be one of a Chinese encoding, an English encoding, a particular pattern, a coordinate position and a combination thereof.

The method further includes the step of providing a timing unit used for calculating a decryption time interval lapsed between decryption passwords of the decryption data based on an input time point corresponding to each one of the decryption passwords of the decryption data; wherein the timing unit is one of a central processing unit (CPU), a microprocessor (MPU), a micro-controller (MUC) and a combination thereof.

In addition, the method includes the step of providing a recording unit for recording a predefined encryption data and a corresponding encryption time interval between encryption passwords of the encryption data as well as storing the decryption data inputted by the user and the decryption time interval corresponding to each one of the decryption passwords of the decryption data; wherein the recording unit is one of a hard disk, USB disk, rewriteable storage media, a cloud hard disk and a combination thereof.

Furthermore, the method includes the step of providing a password verification unit for comparing whether the encryption data matches with the decryption data inputted by the user in order to determine whether an accuracy of the decryption data inputted by the user is verified or not.

Finally, the method further incudes the step of providing a time interval verification unit for determining the accuracy of the authentication password. First, a number of tolerance intervals corresponding to the encryption time intervals are generated based on a particular computation method of the predefined tolerance degrees set by the user and the encryption time intervals; wherein each one of the tolerance degrees is a real number between 0˜1, a lower limit of each one of the tolerance intervals is equivalent to the encryption time interval*(1−the tolerance degree), and an upper limit of each one of the tolerance intervals is equivalent to the encryption time interval*(1+the tolerance degree). Then, the method further includes the step of determining whether the decryption data inputted by the user is accurate based on whether the decryption time intervals inputted by the user are within the corresponding tolerance intervals.

The aforementioned “Summary of the Invention” is for illustrative purposes only and shall not be treated as a limitation to the subject matter claimed. The details of the configurations and technical features of the prevention are described in various embodiments of the present invention as follows.

### BRIEF DESCRIPTION OF THE DRAWINGS

FIG. 1 is a password authentication flow chart of the present invention;

FIG. 2 shows the steps of the password authentication of the present invention;

FIG. 3 is an illustration showing the tolerance intervals of the time interval for authentication of the present invention;

FIG. 4 is an illustration of the first embodiment of the present invention; and

FIG. 5 is an illustration of the second embodiment of the present invention.

### DETAILED DESCRIPTION OF THE INVENTION

To illustrate the technical content, objectives and technical effects to be achieved, the following provides a detailed description on the embodiments of the present invention along with the accompanied drawings.

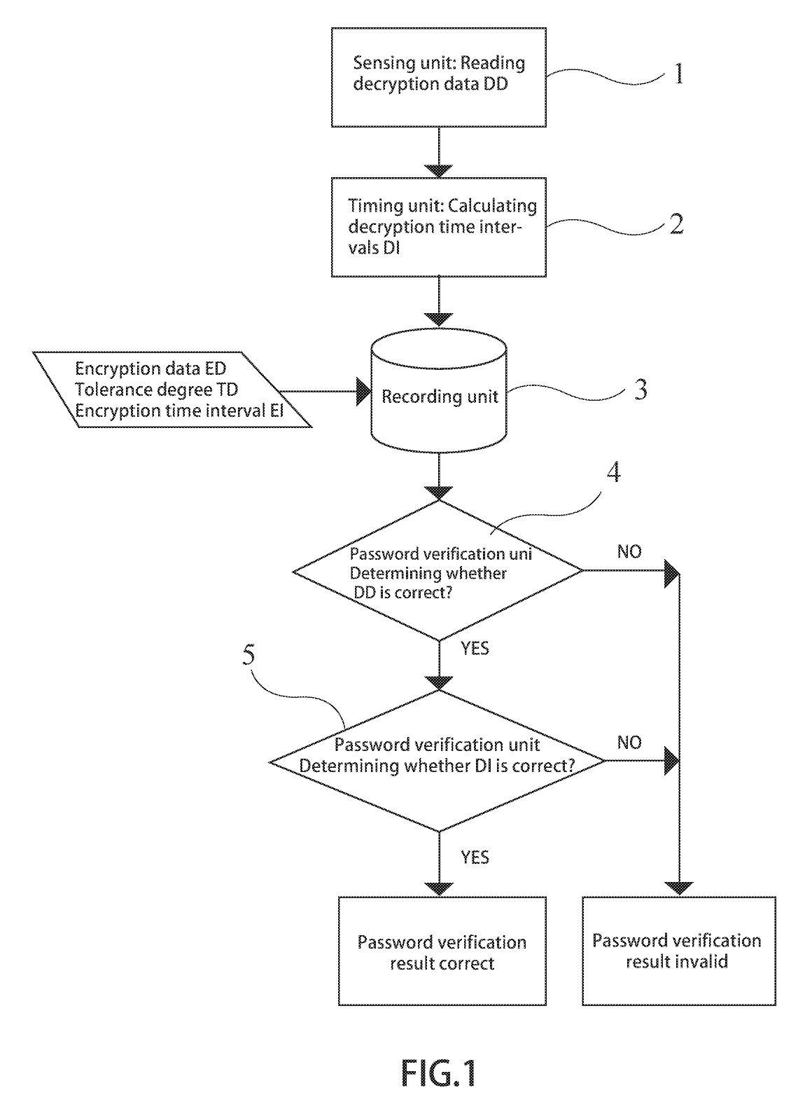

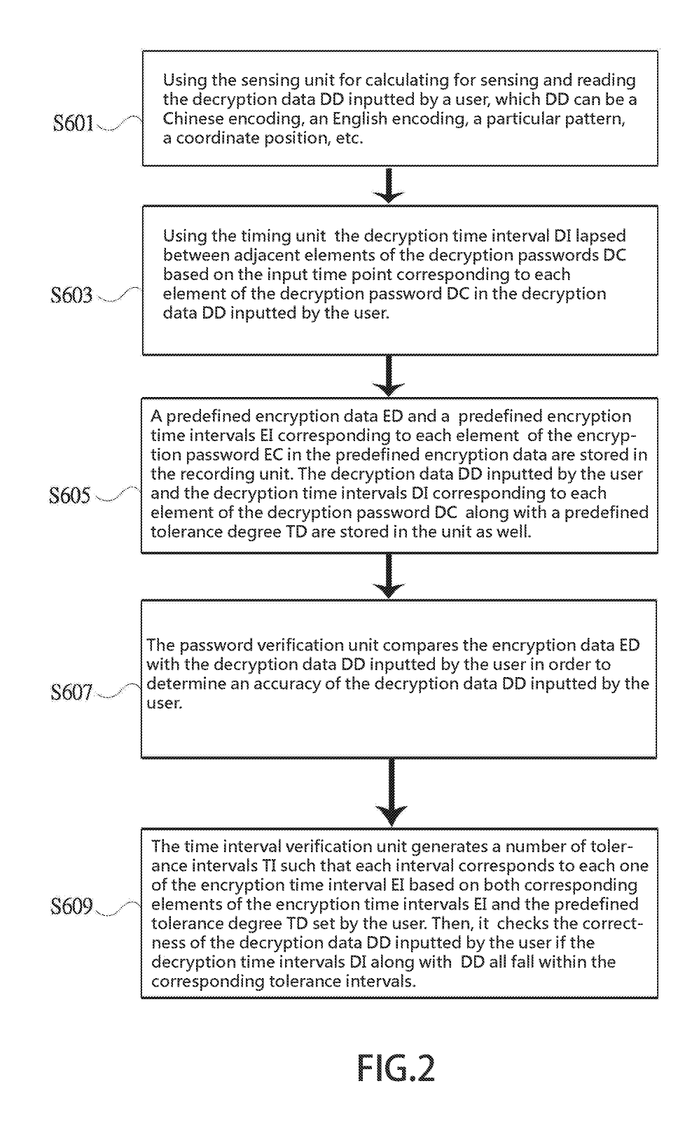

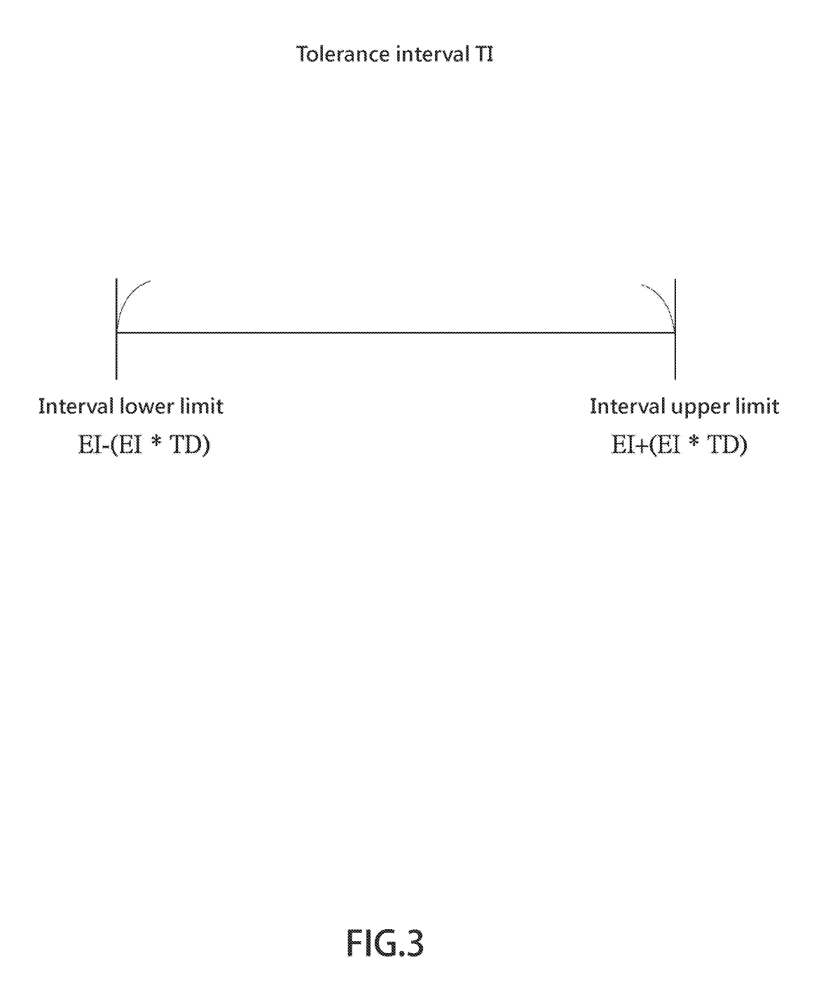

FIG. 1 is a password authentication flow chart of the present invention; FIG. 2 shows the steps of the password authentication of the present invention; FIG. 3 is an illustration showing the tolerance intervals of the time interval for authentication of the present invention. Please refer to FIG. 1 and FIG. 2 first. The detailed descriptions of FIG. 2 correspond to the flows shown in FIG. 1, and from which a clear flow of the input authentication method of the present invention and the corresponding steps of the flows as well as the relationship among the steps can all be understood. First, from the sensing unit shown in the flow chart and the corresponding step S601, it can be understood that the input authentication method includes the step of using a sensing unit 1 for sensing and reading the decryption data DD inputted by a user, and the decryption data can be a Chinese encoding, an English encoding, a particular pattern, a coordinate position, etc. Next, as shown in the flow chart, a timing unit 2 is used, and in step S603, the timing unit 2 calculates the decryption time interval DI lapsed between each one of the decryption passwords DC based on the input time point corresponding to each one of the decryption passwords DC in the decryption data DD inputted by the user. At this time, the recording unit 3 as shown in flow chart and in the corresponding step 605, the recording unit 3 is stored with a set of predefined encryption data ED and predefined encryption time intervals EI corresponding to each one of the encryption password EC in the predefined encryption data, and the recording unit 3 is also stored with the decryption data DD inputted by the user and the decryption time intervals DI corresponding to each one of the decryption passwords DC thereof along with a predefined tolerance degree TD. Following the above, as shown in the flow chart, a password verification unit 4 is used, and in the corresponding step S607, the password verification unit 4 compares whether the encryption data ED matches with the decryption data DD inputted by the user in order to determine an accuracy of the decryption data DD inputted by the user. If the comparison result is true and the encryption data DD matches with the decryption data DD inputted by the user, then as shown in the flow chart, a time interval verification unit 5 and its corresponding step S609 would generate a number of tolerance intervals TI corresponding to each one of the encryption time interval EI based on a particular computation method of the each one of the encryption time intervals EI and the predefined tolerance degree TD set by the user; wherein the tolerance degree TD is a real number between 0˜1. The computation method of the tolerance interval TI uses the value obtained from the equation of EI−(EI*TD) as the lower limit, and the value obtained from the equation of EI+(EI*TD) as the upper limit in order to generate a tolerance interval, which can be expressed by the equation of TI=[EI−(EI*TD), EI+(EI*TD)]. Therefore, the decryption data DD inputted by the user can be further determined to be accurate or not based on whether the decryption time interval DI inputted by the user is within the corresponding tolerance interval TI. If the result shows that it falls within the corresponding tolerance interval TI, it means that the password is verified to be accurate; otherwise it is verified to be incorrect, meaning that during the input of the password combination or particular pattern, the input pace of the password character or pattern stroke clearly differs from the predefined input pace such that it is determined to invalid via the authentication method of the present invention; consequently, the effect of enhancing the protection of the verification of user can be achieved.

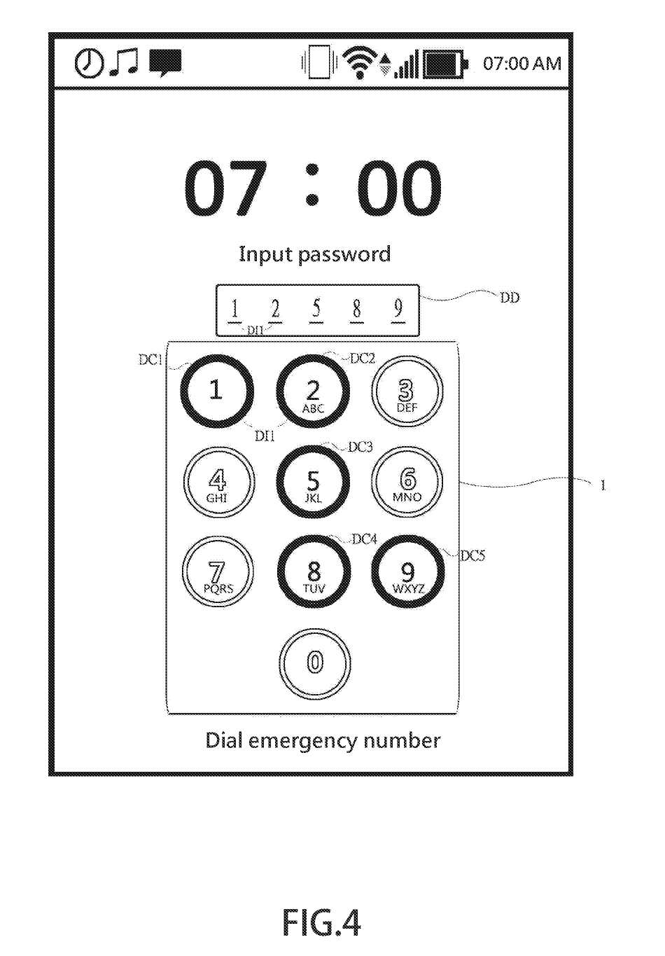

FIG. 4 is an illustration of the first embodiment of the present invention. From FIG. 4, it can be understood that the input authentication method of the present invention can be applied to a common electronic device, such as a smartphone. FIG. 4 shows the unlocking authentication screen during the password input of a smartphone, and the sensing unit 1 is a touch panel. When the user inputs a decryption data DD for unlocking the authentication of the mobile phone, the password verification unit 4 of the present invention determines whether the decryption data DD inputted by the user matches with the predefined encryption data ED completely. It further determines whether the decryption time intervals DI corresponding to each one of the decryption passwords DC 1˜5 in the decryption data DD calculated falls within the corresponding tolerance intervals T1 respectively in order to determine whether the password inputted is correct or not. In this embodiment as shown in the figure, assuming that the decryption time interval DI1 lapsed between the decryption passwords DC1 and DC2 is equivalent to 10 time units, whereas the predefined encryption time interval EI1 is equivalent to 8 time units with the predefined tolerance degree of 0.25, then the corresponding tolerance interval TI can be obtained to be in the range of [8−(8*0.25), 8+(8*0.25)]=[6, 10]. Accordingly, the comparison shows that the decryption time interval DB of 10 time units in this embodiment falls within the corresponding tolerance interval TI. Based on the same principle and the aforementioned steps, the tolerance intervals TI can also be used in the calculations for DC2˜5. As a result, if the corresponding decryption time intervals DI all fall within the corresponding tolerance intervals TI, it can then be determined that the result of the password combination is verified to be correct; otherwise the result would indicate an invalid password combination.

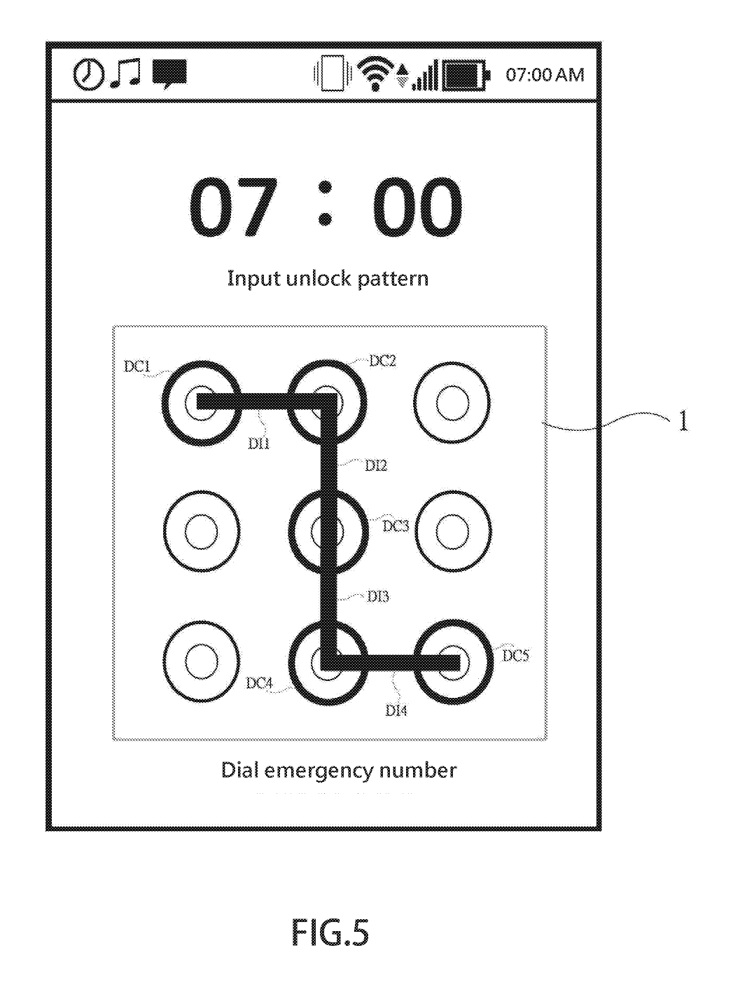

FIG. 5 is an illustration of the second embodiment of the present invention. From FIG. 5, it can be understood that the input authentication method of the present invention can be applied to a common electronic device, such as a smartphone. FIG. 5 shows the unlocking authentication screen during the pattern unlocking of a smartphone, and the sensing unit 1 is a touch panel. When the user inputs a particular pattern as a decryption data DD for unlocking the authentication of the mobile phone, the aforementioned password verification unit 4, similar to that of the first embodiment of the present invention, determines whether the decryption data DD (in this embodiment, it refers to a particular pattern trace) inputted by the user matches with the predefined encryption data ED (in this embodiment, it refers to a particular pattern trace) completely. In addition, it further determines whether the decryption time intervals DI corresponding to each one of the decryption passwords DC 1˜5 in the decryption data DD calculated falls within the corresponding tolerance intervals T1 respectively in order to determine whether the password inputted is correct or not. In this embodiment as shown in the figure, assuming that the decryption time interval DB lapsed between the time when the user makes a stroke from the starting point of the decryption password DC1 to the decryption password DC2 is equivalent to 10 time units, whereas the predefined encryption time interval EI1 is equivalent to 8 time units with the predefined tolerance degree of 0.25, then the corresponding tolerance interval TI can be obtained to be in the range of [8−(8*0.25), 8+(8*0.25)]=[6, 10]. Accordingly, the comparison shows that the decryption time interval DI1 of 10 time units in this embodiment falls within the corresponding tolerance interval TI. Subsequently, the corresponding tolerance intervals TI of the decryption password DC2 and the decryption password DC3 can be calculated. For example, if the predefined encryption time interval EI2 is 4 time units along with the predefined tolerance degree of 0.25, then the decryption time interval DI2 between the decryption passwords DC2 and DC 3 is equivalent to 6 time units, which would yield the determination result that the decryption time interval DI2 fails to fall within the corresponding tolerance interval of TI [3, 5] such that the result of the password authentication is invalid. Based on the same principle and the aforementioned steps, the corresponding decryption time intervals DI2˜4 corresponding to the decryption passwords DC2˜5 can all be calculated for verification unit all of the verification results are correct, the electronic device can then be unlocked; therefore, a more rigorous and secured password authentication mechanism can be achieved.

In view of the above, the present invention provides various specific embodiments as described above; however, the embodiments disclosed are for illustrative purpose only, which shall not be used to limit the scope of the present invention. It can be understood that any person skilled in the art in this field may change or modify the present invention without deviating from the spirit and scope of the present invention. The scope of the present invention shall be determined based on the claims enclosed hereafter, which covers all legitimate equivalent embodiments and shall not be limited to the aforementioned embodiments only.

What is claimed is:

1. An input authentication method, used for verifying an accuracy of a password data inputted by a user, said method comprising:
providing a sensing unit for sensing and reading a decryption data inputted by the user;
providing a timing unit used for calculating a decryption time interval lapsed between decryption passwords of the decryption data based on an input time point corresponding to each one of the decryption passwords of the decryption data;
providing a recording unit for recording a predefined encryption data and a corresponding encryption time interval between encryption passwords of the encryption data as well as storing the decryption data inputted by the user and the decryption time interval corresponding to each one of the decryption passwords of the decryption data;
providing a password verification unit for comparing whether the encryption data matches with the decryption data inputted by the user in order to determine whether an accuracy of the decryption data inputted by the user is verified or not; and
providing a time interval verification unit for generating a number of tolerance intervals corresponding to the encryption time intervals based on a particular computation method of the predefined tolerance degrees set by the user and the encryption time intervals, and further determining whether the decryption data inputted by the user is accurate based on whether the decryption time intervals inputted by the user are within the corresponding tolerance intervals.

2. The input authentication method according to claim 1, wherein the sensing unit is one of a physical keyboard, a virtual keyboard panel, a touch control device, a writing pad and a combination thereof.

3. The input authentication method according to claim 1, wherein each one of the decryption data and the encryption data refers to one of a Chinese encoding, an English encoding, a particular pattern, a coordinate position and a combination thereof.

4. The input authentication method according to claim 1, wherein the timing unit is one of a central processing unit (CPU), a microprocessor (MPU), a micro-controller (MUC) and a combination thereof.

5. The input authentication method according to claim 1, wherein the recording unit is one of a hard disk, USB disk, rewriteable storage media, a cloud hard disk and a combination thereof.

6. The input authentication method according to claim 1, wherein each one of the tolerance degrees is a real number between 0˜1.

7. The input authentication method according to claim 6, wherein a lower limit of each one of the tolerance intervals is equivalent to the encryption time interval*(1−the tolerance degree).

8. The input authentication method according to claim 6, wherein an upper limit of each one of the tolerance intervals is equivalent to the encryption time interval*(1+the tolerance degree).
